(19) United States
(12) Patent Application Publication
(10) Pub. No.: US 2024/0046018 A1
(43) Pub. Date: Feb. 8, 2024

(54) LOGIC CIRCUIT DESIGN METHOD AND LOGIC CIRCUIT DESIGNING APPARATUS

(71) Applicant: RENESAS ELECTRONICS CORPORATION, Tokyo (JP)

(72) Inventor: Hiroshi ISHIYAMA, Tokyo (JP)

(21) Appl. No.: 18/323,851

(22) Filed: May 25, 2023

Related U.S. Application Data
(60) Provisional application No. 63/395,191, filed on Aug. 4, 2022.
(60) Provisional application No. 63/395,742, filed on Aug. 5, 2022.

(51) Int. Cl. G06F 30/367

(52) U.S. Cl. CPC G06F 30/367; G06F 2111/04

(57) ABSTRACT

A method of designing a semiconductor device. It can comprise interpreting a constraint defining a delay value from a timing constraint by inputting data defining a logic circuit and timing constraint data defining a timing constraint relating to the logic circuit, calculating the delay value that can applied to each path in the logic circuit, and verifying the logic circuit by detecting the delay value as a logic verification violation.

### CROSS-REFERENCE TO RELATED APPLICATIONS

The subject application claims benefit of provisional U.S. Patent Application No. 63/395,191, filed on Aug. 4, 2022. The entire disclosure of U.S. Patent Application No. 63/395,191 is incorporated by this reference.

### BACKGROUND

The present invention relates to a design method, a design system, and a storage medium for a semiconductor device, and more particularly, to a design method for a logic circuit formed in a semiconductor device, a design system for executing the design method, and a storage medium storing a program for implementing the design method.

When designing a logic circuit that performs a desired operation, the operation is described in a hardware description language, for example, RTL (Resister Transfer level, the timing constraint of the logic circuit generated based on RTL description is described in, for example, SDC(Synopsys Design Constraint, and the logic circuit is generated using the circuit data SDC described and the timing constraint described.

There are disclosed techniques listed below.
[Patent Document 1] U.S. Patent Publication No. 2016/0055271.

### SUMMARY

In designing a semiconductor-device, the timing constraints described SDC are verified to see if they are valid in the logic-circuit generated based on RTL description. RTL description is generated based on the generated logical circuit, for example, by performing actual operation. For example, verification is performed by performing real-load logic verification using a netlist of logic circuits generated based on RTL description, a SDF (Standard Delay Format that defines a delay time associated with the netlist, or the like. Since netlists, SDF, and the like are required, the verification is performed at a timing close to the final step of the design-method. Therefore, even if a defect is found by verification, there are many steps for correcting the defect, and there is a problem that the correction is not easy.

Other objects and novel features will become apparent from the description of this specification and the accompanying drawings.

A method of designing a semiconductor device according to an embodiment includes: an interpretation step of interpreting a constraint that defines a delay value from a timing constraint by inputting data defining a logic circuit and timing constraint data defining a timing constraint relating to the logic circuit; a calculation step of calculating a delay value that can be given to each path in the logic circuit; and a verification step of detecting the delay value calculated in the calculation step as a logical verification violation.

### BRIEF DESCRIPTION OF THE DRAWINGS

FIG. 1 is a flowchart illustrating an outline of a method for designing a semiconductor device according to Embodiment 1.

FIG. 2 is a diagram for explaining an example of a defect of a timing constraint.

FIG. 3 is a waveform diagram showing a waveform when a logic simulator is implemented using the delay data generated in the step S7_1 according to the first embodiment and a netlist corresponding to the logic circuit LGC1.

FIG. 4 is a flowchart for explaining generating of delay information according to Embodiment 1.

FIG. 5 is a diagram for describing an example of a design method according to Embodiment 1.

FIG. 6 is a diagram for describing an example of a design method according to Embodiment 1.

FIG. 7 is a diagram for describing an example of a design method according to Embodiment 1.

FIG. 8 is a diagram for describing an example of a design method according to Embodiment 1.

FIG. 9 is a diagram for describing an example of a design method according to Embodiment 1.

FIG. 10 is a diagram for describing an example of a design method according to Embodiment 1.

FIG. 11 is a diagram for describing an example of a design method according to Embodiment 1.

FIG. 12 is a diagram for describing a design method according to Embodiment 2.

FIG. 13 is a diagram for describing a design method according to Embodiments 1 and 2.

FIG. 14 is a block diagram illustrating a configuration of a design system according to Embodiment 1.

### DETAILED DESCRIPTION

Hereinafter, an embodiment of the present invention will be described in detail with reference to the drawings. In all the drawings for describing the embodiments, the same parts are denoted by the same reference numerals in principle, and repeated descriptions thereof will be omitted.

### Embodiment 1

(Configuration of Design System)

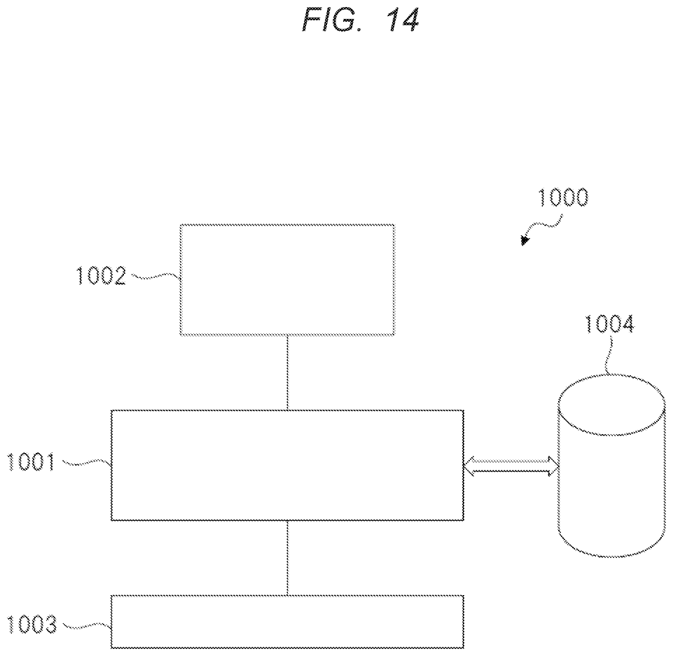

First, a configuration of a design system used in designing a semiconductor device will be described with reference to the drawings. FIG. 14 is a block diagram illustrating a configuration of a design system according to Embodiment 1.

In FIG. 14, reference numeral 1000 denotes a design system. The design system 1000 includes a computer 1001 such as a computer, a display device 1002 connected to the computer 1001, an input device 1003 connected to the computer 1001, and a storage device 1004 connected to the computer 1001.

The computer 1001 operates in accordance with a program stored in the storage device 1004. During this operation, data and the like are input to the computer 1001 and processed by the input device 1003 and the storage device 1004. The computer 1001 displays the result of the processing by, for example, the display device 1002 and stores the result in the storage device 1004.

In the storage device 1004, various design programs for designing a semiconductor device are stored as programs. Here, a case where a design program is stored in the storage device 1004 will be described, but the present invention is not limited thereto. For example, the computer 1001 may be connected to a network (not shown), and may fetch and execute a design program via the network. In this specification, both the storage device 1004 and the network are regarded as a storage medium in which the design program is stored.

(Summary of Design Method of Semiconductor Device)

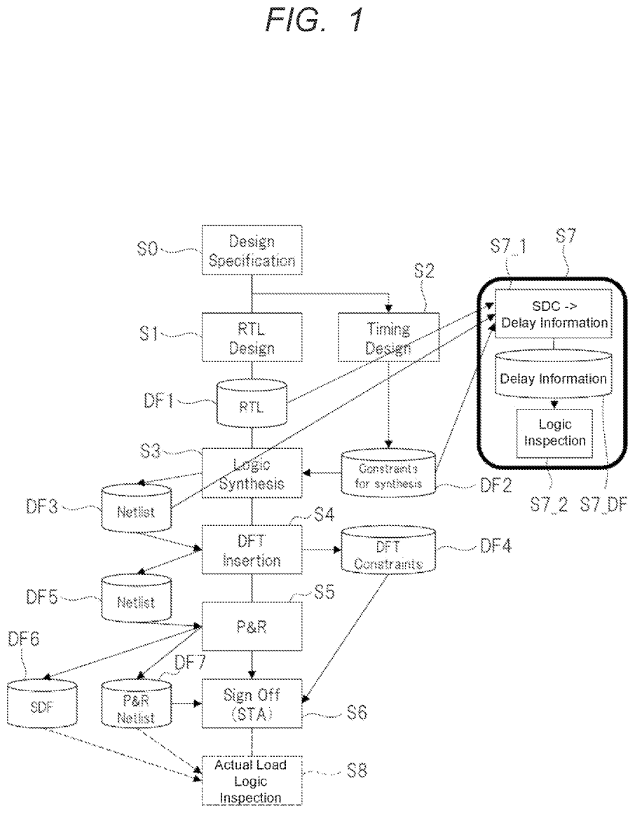

Next, an outline of a method of designing a semiconductor device will be described with reference to the drawings. FIG. 1 is a flowchart illustrating an outline of a method for designing a semiconductor device according to Embodiment 1. The flow illustrated in FIG. 1 is realized by the computer 1001 executing various design programs in the design system 1000 (FIG. 14).

First, in the step S0, the user designs the specifications of the logical circuitry to perform the desired operation.

Based on the specifications designed in the step S0, the user designs a RTL description for defining (generating) the logical circuitry in the step S1. This is realized, for example, by a user creating a RTL description defining a logical circuit in the computer 1001 using the inputting device 1003 shown in FIG. 14. In this way, a RTL description defining the logic-circuit is prepared as a data DF1.

In the step S2, the user designs the times for the logic circuitry. Designs in the step S2 generate timing constraints for the logic circuitry. This provides a timing-constraint data DF2 for the logic-circuit.

In the step S3, the computer 1001 synthesizes the logic-circuit using the data (RTL description) DF1 and the data (timing-constraint) DF2. The synthesizing in the step S3 generates a netlist defining the logic-circuit, and the generated netlist is prepared as a data DF3.

In the step S4, the computer 1001 executes a testing facilitation technique (DFT:Design For Testability). As a result, data for facilitating testing is generated, the generated data is inserted into a data (netlist) DF3, and a netlist for facilitating testing is generated. The generated netlist is prepared as a data DF5. Further, the computer 1001 generates a constraint (hereinafter, also referred to as a DFT constraint) based on the data generated by the testing facilitation technique, and prepares the constraint as a data DF4.

The computer 1001 uses the data DF5 of the netlist to select the gate (logical cell) of the library, arranges the selected gate, and connects the plurality of gates. As a result, a netlist including the arranged gates and the wires connecting the gates is prepared as a data DF7. In addition, the computer 1001 generates data of delay data related to a netlist prepared as a data DF7, and prepares the data as a data DF6.

That is, in the step S5, the computer 1001 selects and arranges a plurality of gates specified by the netlist of the data DF5 from a library of gates prepared in advance. In addition, the computer 1001 connects the selected gates according to the netlist of the data DF5. As a result, a netlist corresponding to the netlist of the data DF5 and a netlist arranged to the wired gates are prepared as the data DF7. In addition, the computer 1001 prepares, for example, a delay value between gates connected by wires as delay information as a data DF6. In the first embodiment, DF6 is in the form of a SDF.

In the step S6, the sign-off is performed, and the designing of the semiconductor device is completed. Note that in the step S6, timing-verification STA may be performed by the computer 1001 using the data DF7 and the data DF4.

By executing the process shown in FIG. 1, a DF6, DF7 or the like required for manufacturing a device having a desired logic-circuit can be prepared.

### Comparative Example

Next, whether or not the timing constraint described in SDC is appropriate will be verified by real-load logic verification with reference to FIG. 1. The actual load logic verification is performed at a timing close to the final step of the design method. In FIG. 1, after signoff (the step S6) is performed, real-load logic validation is performed in the step S8 indicated by a broken line. This is because, in the real-load logic verification, the real operation of the logic circuit is performed by using the data DF7 of the netlist that has been arranged and wired and the data DF6 of the delay information regarding the delay value between the gates connected by the wiring. That is, it is difficult to perform datum load logic verification unless these DF6 and DF7 are prepared, and as shown in FIG. 1, real load logic verification is performed near the final step of the designing process.

If a fault is found by the real-load logic validation performed in the step S8, the user returns to, for example, the step S1 or S2 to review the design of RTL and the design of the timing constraint. After the review, S6 is executed again from the step S3, so that a large number of steps are required to be executed, and a large number of correction steps are required when a defect is found.

In addition, the actual load logic verification is problematic in terms of performance, and it is difficult to implement it for a large-scale logic circuit.

(Logic Verification Using Timing Constraints)

In the first embodiment, instead of the step S6 indicated by the broken line in FIG. 1, the step S7 is performed in the process of designing the device.

The step S7 according to the first embodiment includes steps S7_1 and S7_2. in the step S7_1, the computer 101 (FIG. 14) generates delay information on the constraint from the timing constraint described in SDC which is the data DF2 and the logic circuit of RTL description which is the data DF1 or the logic circuit of the netlist which is the data DF3. The computer 101 prepares the generated delay information as data S7_DF. Thereafter, in the step S7_2, the computer 101 performs a logic simulation to simulate the logic circuit of RTL description or the logic circuit of the netlist using the delay information prepared as the data S7_DF. In this way, the same verification as the real-load logical verification is performed at the step S7.

In the logical simulation in the step S7_2, when a defect is found, the user returns to, for example, the step S1 or S2 to review the design of RTL and the design of the timing constraint. Thus, it is not necessary to perform the step S3 to S6 again, for example, in order to correct the defect, and it is possible to prevent the number of correction steps from increasing. For example, in the step S7_1, when the delay information is generated using the timing constraint described by SDC which is the data DF2 and the logic circuit of RTL description which is the data DF1, the timing constraint can be verified without performing the logic synthesis in the step S3.

An example in which a defect is found and the presence of a defect in the timing constraint described in SDC is verified by performing a logical simulation using the generated delay information will be described next.

(Example of Defect of Timing Constraint)

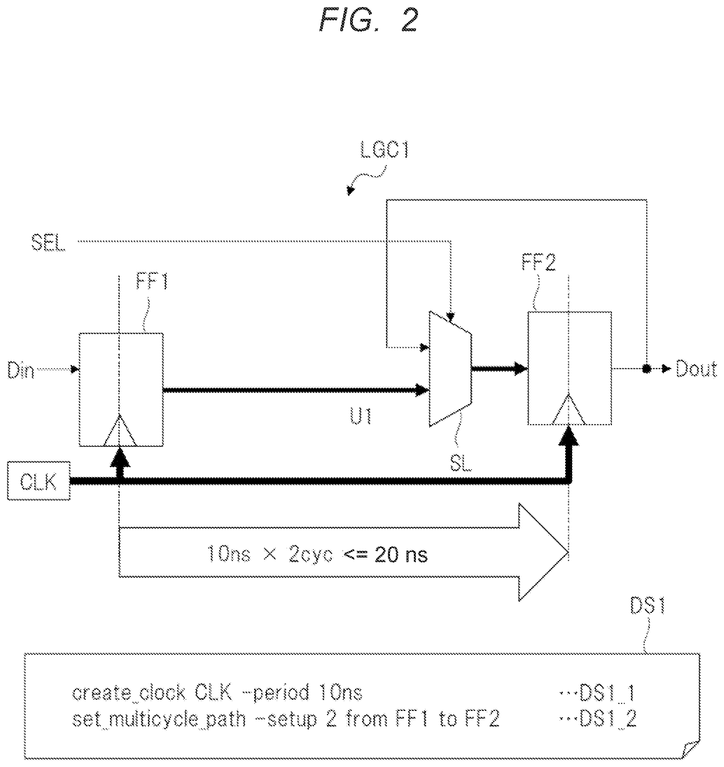

FIG. 2 is a diagram for explaining an example of a defect of a timing constraint. The configuration of the logic circuit according to an exemplary embodiment is defined by a netlist (or RTL) corresponding to the logic circuit, but for ease of explanation, the configuration of the logic circuit defined by the netlist will be described. In FIG. 2, a LGC1 indicates an exemplary logic circuit, and a DS1 indicates a timing constraint (timing constraint described in SDC) related to the logic circuit LGC1.

As shown in FIG. 2, the logic circuit LGC1 includes two flip-flop circuits (hereinafter, also referred to as FF circuits) FF1, FF2 and a selector SL. An output of FF circuit FF1 is connected to one input of the selector SL by a wiring, and an output of the selector SL is connected to an input of FF circuit FF2 by a wiring. The output of FF circuitry FF2 is connected to the other input of the selector SL by a wire and is output as an output Dout.

The output of the selector SL is connected to the input of FF circuit FF2 by a wire. The selector SL operates in accordance with the select signal SEL to provide a signal supplied to one input or the other input to FF circuitry FF2.

As shown in FIG. 2, FF circuitry FF1 and FF2 capture data and provide captured data in synchronization with one common-clock-signal CLK. That is, FF circuitry FF1 takes in the data Din in synchronization with a change (e.g., a rising edge) of the clock signal CLK and supplies it as a signal Ul to one of the selectors SL. FF circuitry FF2 also takes in and outputs the signal output from the selector SL in synchronization with the rising edge of the clock signal CLK.

The timing-constraint DS1 for the logic-circuit LGC1 is described by two descriptive statements SD1_1 and SD1_2, as shown in FIG. 2. Here, the description statement SD1_1 indicates that one cycle of the clock-signal CLK is 10 (ns), and the description statement SD1_2 indicates that there is a multi-cycle path of two cycles between FF circuit FF1 and FF circuit FF2. That is, the timing constraint DS1 illustrated in FIG. 2 specifies that the logical circuit LGC1 transfers data from FF circuit FF1 to FF circuit FF2 within two cycles (20 (ns) of the clock-signal CLK.

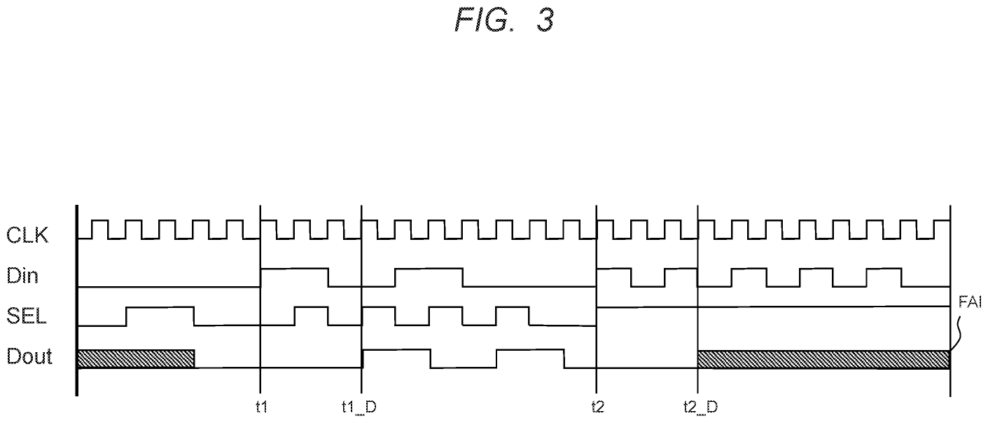

FIG. 3 is a waveform diagram showing a waveform when a logic simulator is implemented using the delay data generated in the step S7_1 according to the first embodiment and a netlist corresponding to the logic circuit LGC1. FIG. 3 shows a state when the select signal SEL is changed every two cycles from the time t1 to the time t2, and after the time t2, the select signal SEL is changed every one cycle.

As can be seen from FIG. 3, between the time t1 and the time t2, an output Dout according to the input Din and the select signal SEL is output from the logic-circuit LGC1. On the other hand, after the time t2, the outputting Dout is undefined. In FIG. 3, the time from the time t1, t2 to the times t1_D and t2_D is a time determined by the delay data generated in the step S7_1 illustrated in FIG. 1. Even after the time t2_D, when the output Dout is indefinite, an indefinite FAI (diagonal line) is generated is detected by the logical simulation. As a consequence, it is found that the timing-constraint DS1 shown in FIG. 2 has a defect.

<Generation of Delay Information>

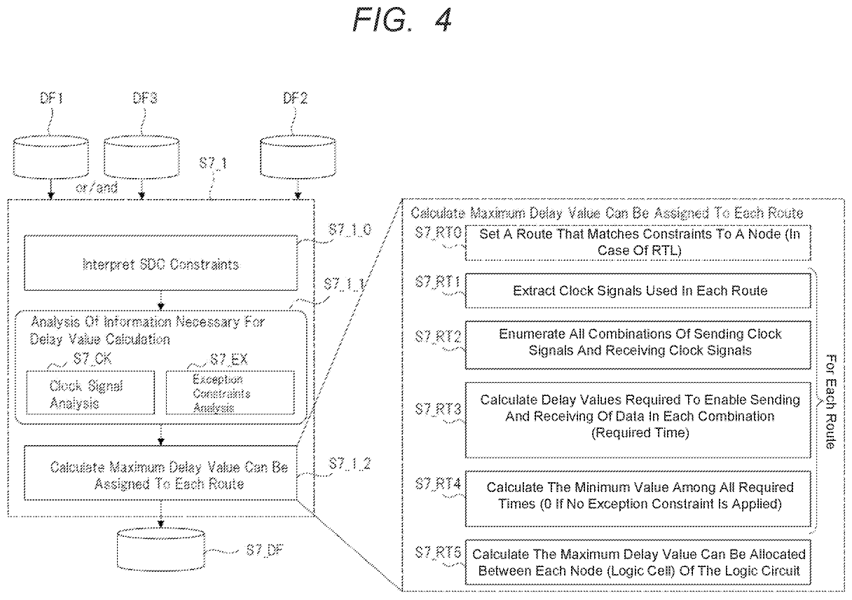

Next, the generation of the delay information described in the step S7_1 of FIG. 1 will be described in more detail with reference to the drawings. FIG. 4 is a flowchart for explaining generating of delay information according to Embodiment 1.

As shown on the left side of FIG. 4, in the step S7_1, the computer 1001 receives DF2 related to the timing constraint described in SDC. Further, in the step S7_1, the data DF1 or the data DF3 of the netlist related to the logical circuitry described in RTL is inputted to the computer 1001. Here, although the data DF1 or the data DF3 is input to the computer 1001 in the step S7_1, the two pieces of data (DF1, DF3) may be mixed and input to the computer 1001.
in the step S7_1, the computer 1001 executes steps S7_1_0, S7_1_1, and S7_1_2 in this order, and stores the delay information generated by the execution of these steps as data S7_DF in the storage device 1004 (FIG. 14).
in the step S7_1_0, the computer 1001 interprets the timing constraint (data DF2) described in SDC. Next, in the step S7_1_1, the computer 1001 executes step S7_CK and step S7_EX for generating information necessary for calculating the delay value. in the step S7_CK, the computer 1001 analyzes the clock signal used in the logic circuit defined by the data DF1 or the data DF3. in the step S7_EX, the computer 1001 analyzes the exceptional constraint based on the timing constraint (data DF3) described in SDC. An example of the exception constraint will be described later, and thus description thereof will be omitted.

Thereafter, in the step S7_1_2, the computer 1001 calculates the maximum delay value that can be assigned to each path. Here, the path represents a path connecting at least two gates in a logic circuit defined by the data DF1 or the data DF3. Details of this step S7_1_2 are shown on the right side of FIG. 4. Next, steps S7_RT0 to S7_RT5 executed by the computer 1001 in the step S7_1_2 will be described.

<Description of Step S7_1_2 for Calculating the Maximum Delay Value that can be Given to Each Path>

Here, a case where the computer 1001 calculates the maximal delay by inputting the data DF1 related to the timing constraint and the data DF3 of the netlist will be described with reference to FIG. 4. Instead of the data DF3 of the netlist, the data DF1 described in RTL will be described in the second embodiment, and therefore will not be described here.
in the step S7_1_2, the computer 1001 executes steps in order from step S7_RT0 to RT_5. Here, since the first step S7_RT0 is a step executed by the computer 1001 when the data DF described in RTL is inputted, the first step S7_RT0 will be described later in Embodiment 2.
in the step S7_RT1, the computer 1001 extracts a clock-signal used in a path connecting at least two gates in a logic-circuit defined by a netlist that is a data DF3. Since the logic circuit usually includes a plurality of paths, the computer 1001 extracts a clock signal to be used for each path in the step S7_RT1.

The computer 1001 lists all combinations of the transmission-side clock signal and the reception-side clock signal for the clock signal extracted in the step S7_RT1 in the step S7_RT2. That is, when data propagates through a path connecting two gates, a clock signal used at a gate side that transmits the data is used as a transmission side clock signal, and a clock signal used at a gate side that receives the data is used as a reception side clock signal. in the step S7_RT2, the computer 1001 lists the combinations of all the paths using the transmission-side clock signal and the reception-side clock as a set.

Next, in the step S7_RT3, the computer 1001 calculates a delay value that needs to be satisfied at a minimum in order to be able to transmit and receive data in each combination of the transmission-side clock signal and the reception-side clock signal. Hereinafter, this delay is also referred to as a Required Time.
in the step S7_RT4, the computer 1001 calculates the minimum value from all the request times calculated in the step S7_RT3. For a path to which the exception constraint is not applied, the computer 1001 sets “0” as the minimum value.
in the step S7_RT5, the computer 1001 calculates the maximum delay value (maximum delay value) that can be allocated (assigned) to the path connecting the gates constituting the logic circuit. The computer 1001 sets the maximum delay value calculated in the step S7_RT5 as delay information.

<Example of Calculation of Maximum Delay Value>

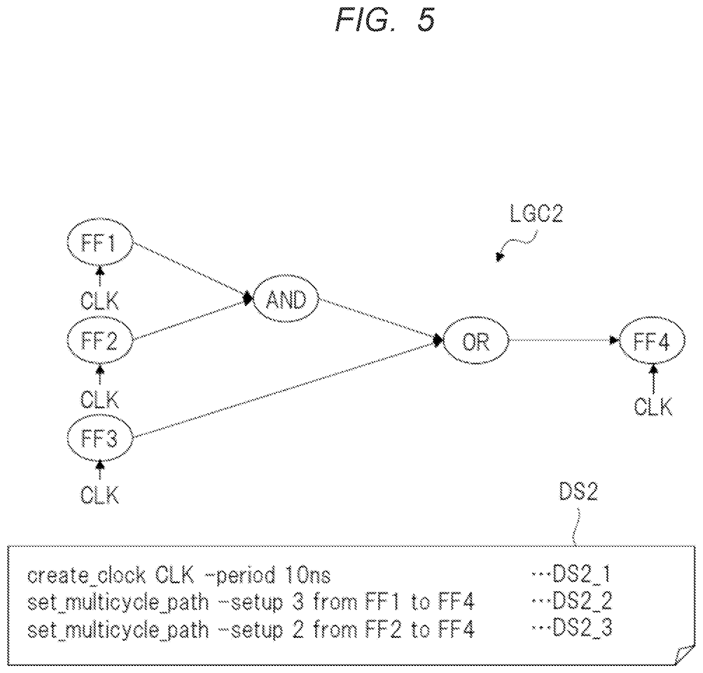

Next, an example of calculating the maximum delay value by executing steps S7_RT1 to S7_RT5 will be described with reference to the drawings. FIG. 5 to FIG. 11 are diagrams for describing an example of a design method according to Embodiment 1. Here, an example in which a netlist is used in designing a logic circuit will be described, but for ease of explanation, a schematic configuration of a circuit defined by the netlist is shown in FIGS. 5 to 11.

First, the configuration of the logic circuit LGC2 designed in the first embodiment and the timing-constraint DS2 related to the logic circuit LGC2 will be described with reference to FIG. 5.

The logic circuit LGC2 includes FF4 from FF circuit FF1, an AND circuit AND, and an OR circuit OR. A clock signal CLK is supplied from FF circuit FF1 to each clock terminal of FF4. Taking FF circuit FF1 as an example, FF circuit FF1 takes in and outputs data in synchronization with a change in the clock signal CLK. FF circuits FF2 to FF4 are the same as FF1 of FF circuits.

In the logic circuit LGC2, the output of FF circuit FF1 and FF circuit FF2 is input to the AND circuit AND, the output of the AND circuit AND and the output of FF circuit FF3 are input to the OR circuit OR, and the output of the OR circuit OR is input to FF circuit FF4.

Three descriptive statements DS2_1 to DS2_3 are described in the timing-constraint DS2 related to the logic-circuit LGC2 as shown in FIG. 5.

Here, the description statement DS2_1 indicates that one cycle of the clock-signal CLK is 10 (ns). The description statement SD2_2 indicates that there is a multi-cycle path of three cycles between FF circuit FF1 and FF4 circuit. That is, in the timing constraint DS2 shown in FIG. 3, it is specified that the logical circuit LGC2 transfers data from FF circuit FF1 to FF circuit FF4 within three cycles (30 (ns) of the clock-signal CLK. The description statement SD2_3 indicates that there is a multi-cycle path of two cycles between FF circuit FF2 and FF circuit FF4. That is, in the logical circuit LGC2, it is stipulated that the transfer of the data from FF circuit FF2 to FF circuit FF4 is not more than two cycles (20 (ns) of the clock signal CLK.

In the timing-constraint DS2, the exceptional constraint corresponds to the descriptive statements DS2_2 and DS2_3. That is, in the example of the timing-constraint DS2, the exception constraint is a portion where a multi-cycle path exists, and the exception constraint is applied to a path connecting FF circuit FF1 and FF circuit FF4 and a path connecting FF circuit FF2 and FF circuit FF4.

Using the logic-circuit LGC2 and the timing-constraint DS2 illustrated in FIG. 5, the computer 1001 executes steps S7_RT1 to S7_RT5 illustrated in FIG. 4.

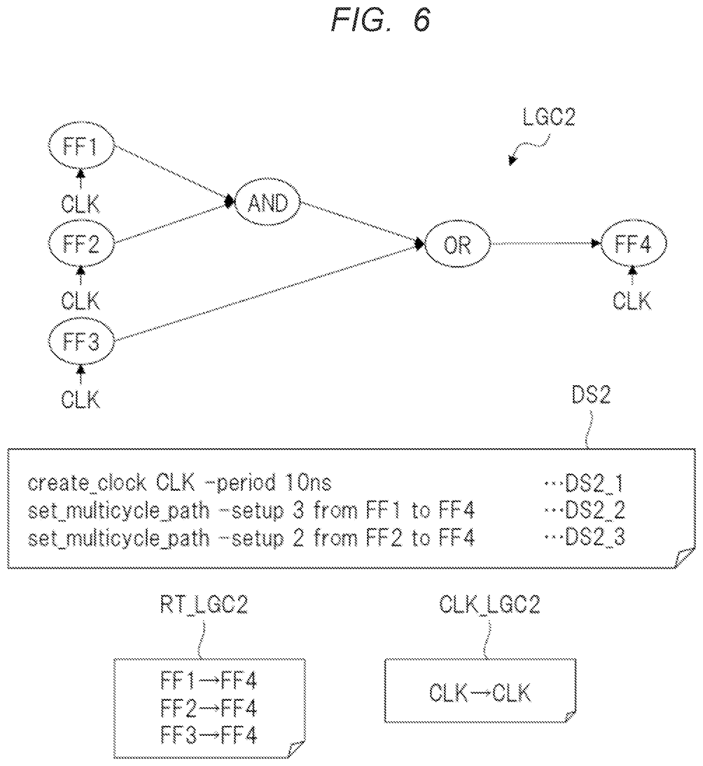

FIG. 6 is a diagram for explaining step S7_RT1 and step S7_RT2. in the step S7_RT1, a clock signal used in each path is extracted. In the logic-circuit LGC2, as indicated by reference numeral RT_LGC2 in FIG. 6, there are three paths. That is, the logical circuit LGC2 has a path (FF) connecting FF2→FF4 circuit FF1 and FF circuit FF4, a path (FF) connecting FF3→FF4 circuit FF2 and FF circuit FF1→FF4, and a path connecting FF circuit FF3 and FF circuit FF4. Since the clock signal used in FF circuit FF1 from FF circuit FF4 is only the clock signal CLK, only the clock signal CLK is extracted by executing step S7_RT1.

By executing step S7_RT2, all combinations of the transmission-side clock signal and the reception-side clock signal are enumerated. In FIG. 6, referring to FF1→FF4, the data propagates from FF circuit FF1 toward FF circuit FF4. Therefore, FF circuit FF1 corresponds to the transmission-side gate, and FF4 of FF circuit corresponds to the reception-side gate. In the logic-circuit LGC2, only the clock signal CLK is used, and therefore, in the path (FF1→FF4), the combination of the transmission-side clock signal and the reception-side clock signal becomes the clock signal CLK→CLK. Since the other paths are the same as those of the path (FF1→FF4), only the combinations of the clock-signal CLK→CLK are listed by executing step ST7_RT2, as indicated by reference numeral CLK_LGC2 in FIG. 6. In the following drawings, the clock-signal CLK supplied to FF circuitry is omitted.

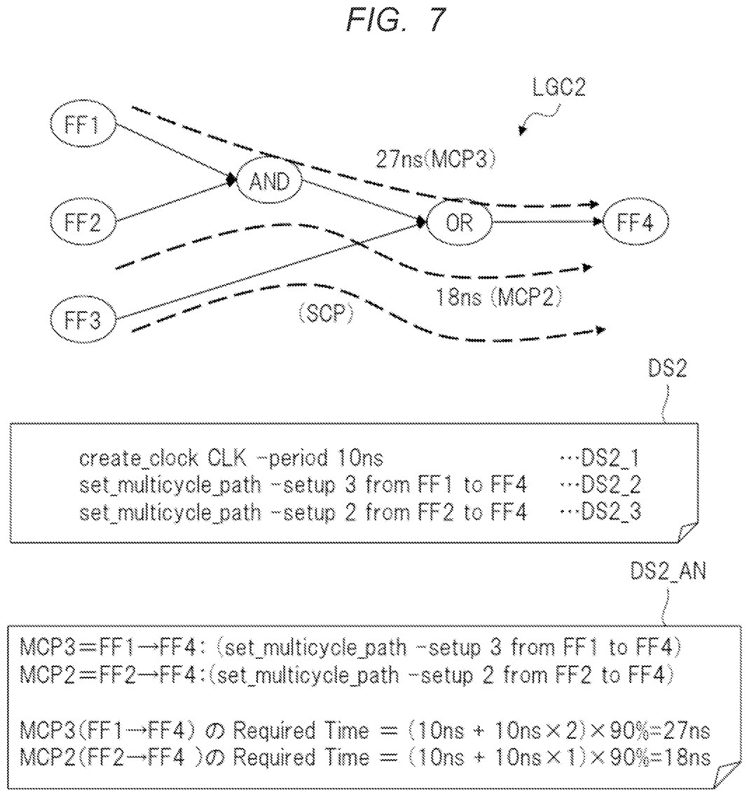

Next, the request time is calculated by executing step S7_RT3. FIG. 7 is a diagram for explaining this step S7_RT3.

In FIG. 7, a path (FF1→FF4) to which a multi-cycle that is an exception constraint is applied is represented by a code MCP3, and a path (FF2→FF4) to which a multi-cycle that is an exception constraint is applied is represented by a code MCP2. Further, a path (FF3→FF4) to which the exceptional constraint is not applied is represented by a reference numeral SCP in FIG. 7.

As shown in FIG. 6, the combination of the transmission-side clock signal and the reception-side transmission clock signal for each of the paths MCP2 and MCP3 is one (clock signal CLK). Therefore, in the clock-signal CLK, the delay required to allow the path MCP2 and MCP3 to be transmitted and datum is calculated based on the timing-constraint DS2, as indicated by the code DS2_AN.

First, in the path MCP3, since the multi-cycle is three cycles, as shown in DS2_AN, the delay of the path MCP3 is calculated as (10 (ns)+10 (ns)×2)×90%=27 (ns). In this calculation, the worst case of the timing of change in the clock-signal CLK is considered and multiplied by 90%. Note that 90% is an example and is not limited to this value. Similarly, in the path MCP2, since the multi-cycle is two cycles, the delay for the path MCP2 is calculated as (10 (ns)+10 (ns)×2)×90%=27 (ns). Here, the reason for multiplying by 90% is the same as that for the path MCP3.

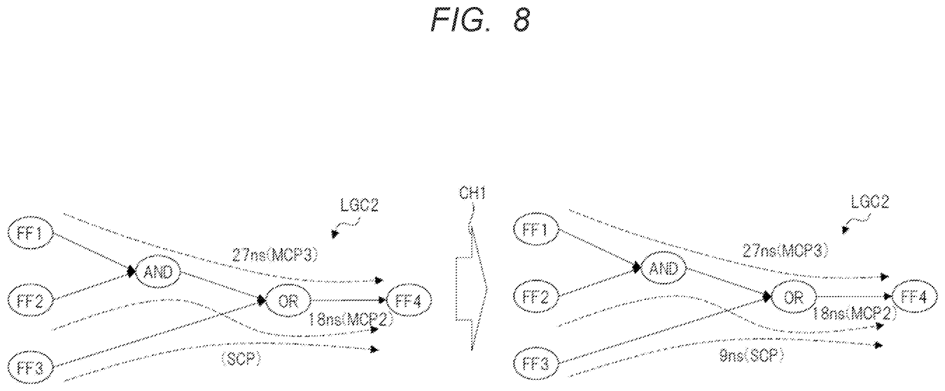

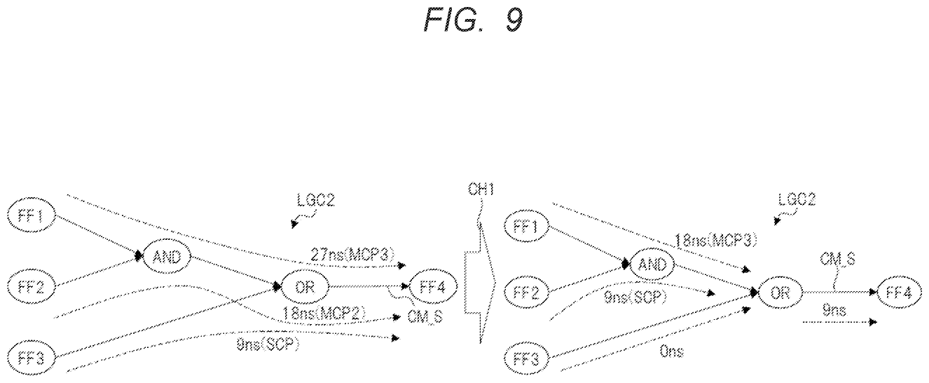

By executing step S7_RT4, the smallest value is calculated from all delay values (Required Time). FIG. 8 and FIG. 9 are diagrams for explaining step S7_RT4.

In FIG. 8, since the state of the logic circuit LGC2 shown on the left side of the arrow CH1 is the same as the state of the logic circuit LGC2 shown in FIG. 7, the explanation thereof will be omitted. in the step S7_RT4, when the path to which the exception constraint is applied and the route to which the exception constraint is not applied merge or branch, the delay value is also set for the route to which the exception constraint is not applied. In the logic-circuit LGC2 shown on the left side of FIG. 8, the path SCP corresponds to a path to which no exceptional constraint is applied. Therefore, in the logical circuit LGC2, the path SCP and the path MCP2 merge in OR circuit OR. Therefore, the delay is also set in the path SCP. Here, the delay set in the path SCP is 1 cycle (10 (ns))×90%=9 (ns). Here, 90% is a value determined in consideration of the worst case of the timing of change in the clock-signal CLK. As a result, as shown on the right side of the arrow CH1 in FIG. 8, the delay added to each of the path SCP, MCP2 and MCP3 is calculated.

Next, the computer 1001 executes the processing illustrated in FIG. 9. In FIG. 9, the state of the logic circuit LGC2 shown on the left side of the arrow CH1 is similar to the state of the logic circuit LGC2 shown on the right side of the arrow CH1 in FIG. 8. The difference is that FIG. 9 clearly shows that the path connecting the OR circuit OR and FF circuit FF4 is the common path CM_S. That is, it indicates that the path (common path CM_S) connecting the OR circuit OR and FF circuit FF4 is commonly used in the path SCP to which the exception constraint is not given and the path (MCP2, MCP3) to which the exception constraint is given.

The computer 1001 subtracts the delay value 9 (ns) of the path SCP without the exceptional constraint from the time of the common path CM_S. The computer 1001 sets the subtracted delay value of the path SCP as the delay value of the common path CM_S. Further, the computer 1001 subtracts the delay value set in the common path CM_S from the delay value of the path MCP2, MCP3 to which the exceptional constraint is attached. By this subtraction, the delay value of the path MCP2 becomes 18 (ns), and the delay value of the path MCP3 becomes 9 (ns). The delay values 18 (ns) and 9 (ns) calculated by subtracting are the smallest values of the request times (Required Time) of the path MCP2, MCP3 to which the exceptional constraint is attached. In addition, the delay of the path SCP to which the exceptional constraint is not attached is 0 (ns). In FIG. 9, the state of the logic circuit LGC2 at this time is shown on the right side of the arrow CH1 of the logic circuit LGC2.

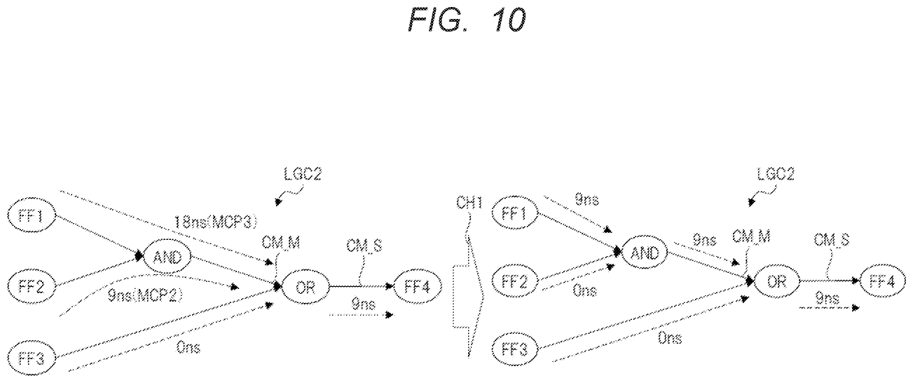

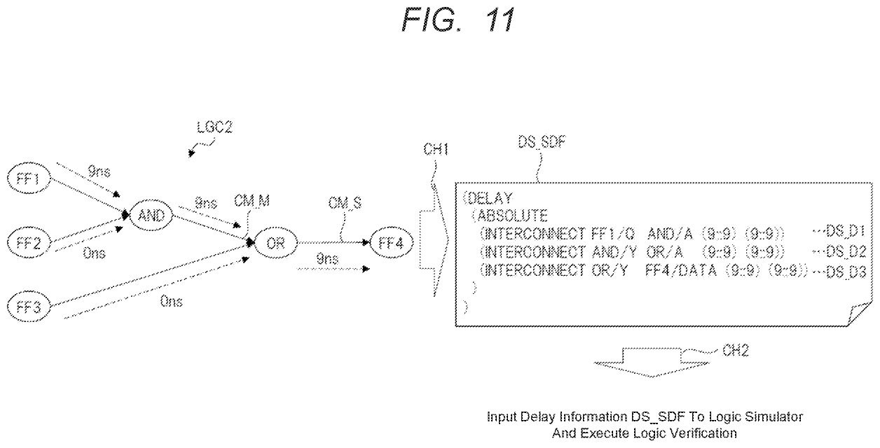

Next, as illustrated in FIG. 4, the computer 1001 executes step S7_RT5. The processing executed in the step S7_RT5 is shown in FIG. 10 and FIG. 11.

In FIG. 10, the state of the logic-circuit LGC2 shown on the left side of the arrow CH1 is similar to the state shown on the right side of the arrow CH1 in FIG. 9. The difference is that FIG. 10 clearly shows that the path connecting the AND circuit AND and the OR circuit OR is the common path CM_M. That is, the path MCP2 and MCP3 to which the exception constraint is attached merge in the AND circuit AND, and the path connecting the AND circuit AND and the OR circuit OR is shared by the two paths to which the exception constraint is attached, indicating that the path is the common path CM_M.

When the path to which the exceptional constraint is attached merges or branches at the gate (the AND circuit AND in the example of FIG. 10), the computer 1001 sets the path overlapping between the paths to the common path CM_M, and sets the smallest value (1 cycle×90%=9 (ns) in the example of FIG. 10) as the delay value of the common path CM_M. Thereafter, the computer 1001 subtracts the delay value of the common path CM_M from the path MCP2, MCP3 to which the exceptional constraint calculated in the step S7_RT4 is added, and recalculates the delay value of the path MCP2, MCP3. By this re-calculation, the delay of the path MCP2 becomes 0 (ns), and the path MCP3 becomes 9 (ns).

Thus, in FIG. 10, as shown on the right side of the arrow CH1, a path connecting FF circuit FF1 and the AND circuit AND, a path connecting FF circuit FF2 and the AND circuit AND, a path connecting the AND circuit AND and the OR circuit OR, a path connecting FF circuit FF3 and the OR circuit OR, and a delay value allocated to each of the paths connecting the OR circuit OR and FF circuit FF4 are calculated. In the embodiment illustrated in FIG. 10, a delay value of 9 (FF1) is assigned to a path connecting FF circuit ns and the AND circuit AND, a delay value of 9 (ns), a delay value of 0 (ns), and a path connecting the AND circuit AND and the OR circuit OR are assigned to a path connecting FF circuit FF2 and the AND circuit AND. A delay value of 9 (ns) is assigned to a path connecting FF circuit FF3 and the OR circuit OR to a delay value of 0 (ns) and a path connecting the OR circuit OR and FF circuit FF4.

Thus, in the logic circuit LGC2, the largest delay that can be allocated between the logic cells (FF circuit, the AND circuit, and the OR circuit in FIG. 10) is calculated. Note that since the logical cell can be regarded as a node when viewed in a netlist, for example, it may be regarded that the maximum delay value that can be allocated between the nodes is calculated.

Next, the computer 1001 executes the processing illustrated in FIG. 11. In FIG. 11, the state of the logic-circuit LGC2 shown on the left side of the arrow CH1 is the same as that shown on the right side of the arrow CH1 in FIG. 10, and therefore will not be described. The computer 1001 outputs, as delay information, a maximum delay value excluding a delay value of 0 (ns) among the maximum delay values that can be allocated between logical cells. In FIG. 11, the computer 1001 describes the largest delay value in SDF and outputs the largest delay value. This is illustrated on the right side of the arrow CH1.

In other words, in FIG. 11, DS_SDF indicates delay data in which the calculated maximal delay data is described by SDF. In the delay information DS_SDF, the description statement DS_D1 indicates that the delay value of the path connecting the output (Q) of FF circuit FF1 and the input (A) of the AND circuit AND is 9 (ns), the description statement DS_D2 indicates that the delay value of the path connecting the output (Y) of the AND circuit AND and the input (A) of the OR circuit OR is 9 (ns), and the description statement DS_D3 indicates that the delay value of the path connecting the output (Y) of the OR circuit OR and the input (DATA) of FF circuit FF4 is 9 (ns).

The delay data DS_SDF outputted from the computer 1001 is inputted to a logical simulator as shown below the arrow CH2 in FIG. 11. The computer 1001 executes a logic simulation by using the delay information DS_SDF as data for determining that the delay information DS_SDF is a logical verification violation. That is, in the logical simulation, when there is a delay exceeding the delay information DS_SDF, the logical simulator determines that the delay is a violation.

### Embodiment 2

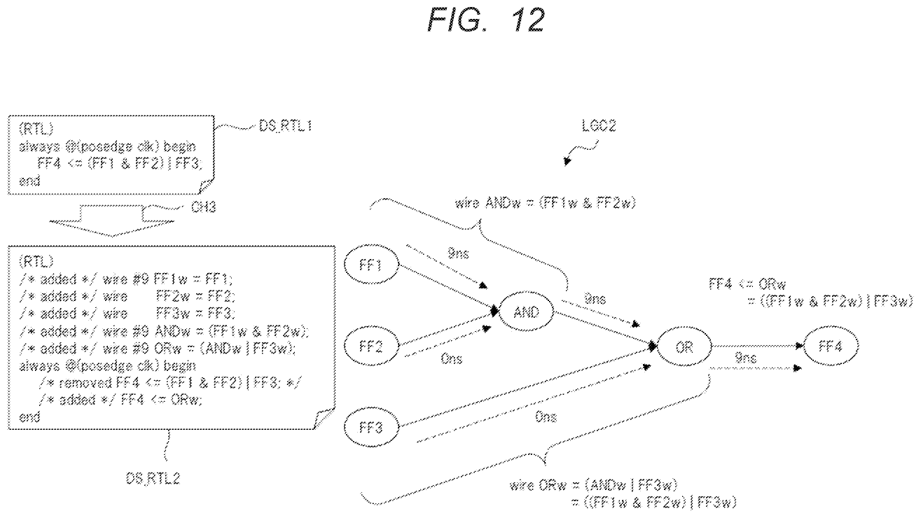

Next, instead of the data DF3 of the netlist, the data DF1 of RTL description that defines the logic-circuit is inputted to step S7_1 shown in FIG. 4 will be described with reference to the drawings. FIG. 12 is a diagram for describing a design method according to Embodiment 2. Here, the same logic circuit LGC2 as the logic circuit described in the first embodiment is designed.

When the data DF1 of RTL description is inputted to step S7_1, the computer 1001 first executes step S7_RT0 in the step S7_1_2.

in the step S7_RT0, the computer 1001 sets a path corresponding to the constraint as a node. Thereafter, the computer 1001 executes the above-described steps S7_RT1 to S7_RT5.

In FIG. 12, DS_RTL1 above the arrow CH3 indicates a RTL description that defines the logic-circuit LGC2. In the second embodiment, in the step S7_RT0, the computer 1001 converts the operators RTL described (for example, &, |, and the like) into logical cells (for example, AND circuit AND, OR circuit OR, and the like) used in the description of the netlist, and assigns the output signal of FF circuit to the wire (wire). Further, the computer 1001 divides each operator into assignments, and deletes a description statement (FF4<=(FF1 & FF2)|FF3) existing in the original RTL description. As a result, RTL description DS_RTL1 generates RTL description DS_RTL2 as shown below the arrow CH3. In RTL description DS_RTL2, the /* added */ at the beginning of the description statement indicates a description statement in which the description statement is added to the original RTL. In addition, in RTL description DS_RTL2, description statement /* removed FF4<=(FF1 & FF2)|FF3 */ indicates to remove from the original RTL. In addition, it can be deleted by processes, operations, and the like in various tools related to the designing support, regardless of the descriptive text of RTL.

Thereafter, the computer 1001 executes steps S7_RT1 to S7_RT5 to calculate the delay value in the same manner as in the first embodiment. The calculated delay value is applied to the wire to be applied using a known technique. As a result, in FIG. 12, a delay is given between the logic cells as in the logic circuit indicated by reference numeral LGC2. After that, the delay values (9 (ns)) assigned between the logical cells are inputted to the logical simulator as delay information.

According to the second embodiment, the timing constraint can be efficiently verified even if the logic circuitry is defined in RTL description.

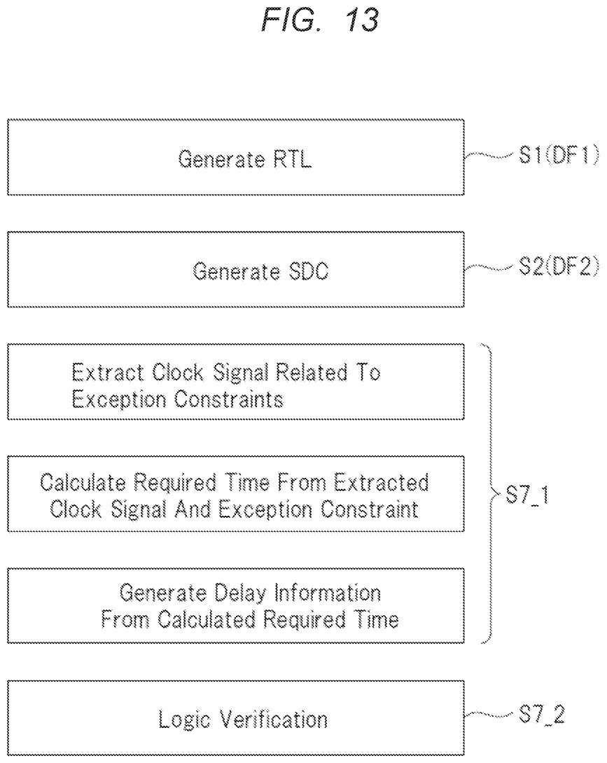

FIG. 13 is a diagram for describing a design method according to Embodiments 1 and 2. With reference to FIG. 13, the outline of the first and second embodiments will be described as follows. That is, in the step S1, a description defining the configuration of the logical circuitry to be designed is created (RTL creation), and in the step S2, a description defining the timing constraint is created (SDC creation). Thereafter, in the step S7_1, the computer 1001 executes the program, thereby extracting a clock signal related to the exception constraint based on the created timing constraint, calculating a request time (Required Time) from the extracted clock signal and the exception constraint, and generating delay information from the calculated request time. With the generated delay information as a restriction for verification, the computer 1001 executes the logical verification in the step S7_2.

Although the invention made by the present inventors has been described in detail based on the embodiments, it is needless to say that the present invention is not limited to the above-described embodiments and can be variously modified without departing from the gist thereof.

What is claimed is:

1. A method of designing a semiconductor device, comprising:
(a) interpreting a constraint defining a delay value from a timing constraint by inputting data defining a logic circuit and timing constraint data defining a timing constraint relating to the logic circuit;
(b) calculating the delay value that can applied to each path in the logic circuit; and
(c) verifying the logic circuit by detecting the delay value as a logic verification violation.

2. The method according to claim 1, wherein the (b) calculating comprises:
(b1) extracting a output-side clock used on the output side for output data and a input-side clock used on the input side for input data in each of the paths;
(b2) enumerating all combinations of the output-side clock and the input-side clock;
(b3) extracting a clock path involving the output side and the input side; and
(b4) calculating a minimum delay value that allows data to be transmitted between the output side clock and the input side clock.

3. The method according to claim 2, wherein the (c) verifying includes a functional verification by hardware and software.

4. The method according to claim 3,
wherein the data defining the logic circuit is described in RTL, and
wherein the timing constraint data is described in SDC.

5. The method according to claim 3,
wherein the data defining the logic circuit is described in netlist, and
wherein the timing constraint data is described in SDC.

6. A logic circuit designing apparatus comprising:
a computer;
an input device connected to the computer; and
an display device connected to the computer,
wherein the computer is configured to execute:
(a) interpreting a constraint defining a delay value from a timing constraint by inputting data defining a logic circuit and timing constraint data defining a timing constraint relating to the logic circuit;
(b) calculating the delay value that can applied to each path in the logic circuit; and
(c) verifying the logic circuit by detecting the delay value as a logic verification violation.

7. The apparatus according to claim 6, wherein the (b) calculating comprises:
(b1) extracting a output-side clock used on the output side for output data and a input-side clock used on the input side for input data in each of the paths;
(b2) enumerating all combinations of the output-side clock and the input-side clock;
(b3) extracting a clock path involving the output side and the input side; and
(b4) calculating a minimum delay value that allows data to be transmitted between the output side clock and the input side clock.

8. The method according to claim 7, wherein the (c) verifying includes a functional verification by hardware and software.
